(19) United States
(12) Patent Application Publication
(10) Pub. No.: US 2005/0262032 A1
(43) Pub. Date: Nov. 24, 2005

(54) Portal rules engine enhancements

(75) Inventor: Gregory Smith, Westminster, CO (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/130,514

(22) Filed: May 17, 2005

Related U.S. Application Data
(60) Provisional application No. 60/573,201, filed on May 21, 2004.

(51) Int. Cl. G06F 17/00; G06N 5/02; G06F 15/18

(52) U.S. Cl. 706/47

(57) ABSTRACT

In one embodiment, a condition of a rule is evaluated. If the condition evaluates to true, a step defined by an action of the rule is done. The evaluating or doing step can includes executing a control defined in condition or action of the rule. The control is an object that encapsulates business logic or provides access to a resource.

### CLAIM OF PRIORITY

This application claims priority to U.S. Provisional Application No. 60/573,201 entitled “Portal Rules Engine Enhancements” filed May 21, 2004. [Attorney's Docket No. BEAS-01620US1]

### BACKGROUND OF THE INVENTION

The present invention disclosure generally relates to rule engine.

### BRIEF DESCRIPTION OF THE DRAWINGS

FIG. 1 is a illustration of rule including a control in the condition or action.

FIG. 2 is a illustration of ruleset including multiple rules, a rule engine and a control execution unit.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Embodiments of the present invention concern the use of controls in rules. A control is an object that encapsulates business logic or provides access to a resource. Examples of Controls include Java Controls, Built-in Controls of an Integrated Development Environment (IDE), or Custom Controls A rule is a type of if/then statement with a condition (if) that is evaluated and an action (then) that occurs if the condition is true.

The condition “if” portions of rules contain conditions such as “shoppingCart.totalAmount>$100”. The “then” portions of rules contain actions such as “recommendDiscount(5%)”. The inputs to a rule engine can be groups of rules, called rulesets, and some data objects (such as objects of a working memory). The outputs from a rule engine are determined by the inputs and may include the originally inputted data objects with possible modifications, new data objects and side effects such as “sendMail(‘Thank you for shopping’).”

An Integrated Development Environment (IDE), such as WebLogic® Workshop (available from BEA Systems, Inc. of San Jose, Calif.), can provide controls (e.g., Java® controls) that make it easy for users to encapsulate business logic and to access enterprise resources such as databases, legacy applications, and web services. In addition to built-in controls, Custom controls and Portal controls can also be used.

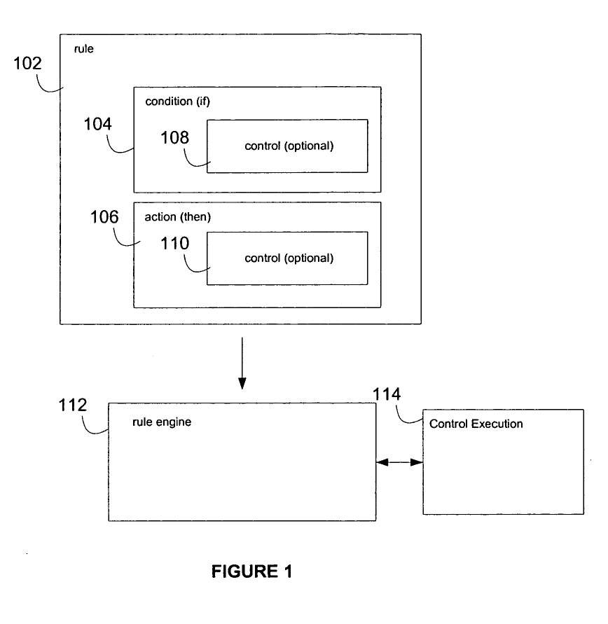

In one embodiment of the present invention, a control can be invoked in the condition(if) or action(rule) portion of a rule. FIG. 1 shows a rule 102 with a condition portion 104 and an action portion 106. Controls 108 in the condition portion 104 of the rule 102 can be used to produce a Boolean value for the condition. Controls 110 in the Action portion 106 can be run as a result of the condition portion 104 being evaluated as true.

The rules engine 112 given the rule 102 to execute evaluates the condition portion 104. This may include executing a control 108 with control execution unit 114. The rules engine 112 and control execution unit 114 can be part of a server, such as the WebLogic® Server product available from BEA Systems, Inc. If the condition 108 evaluates to true, then action 106 is done. This can include executing the control 110 with control execution unit 114.

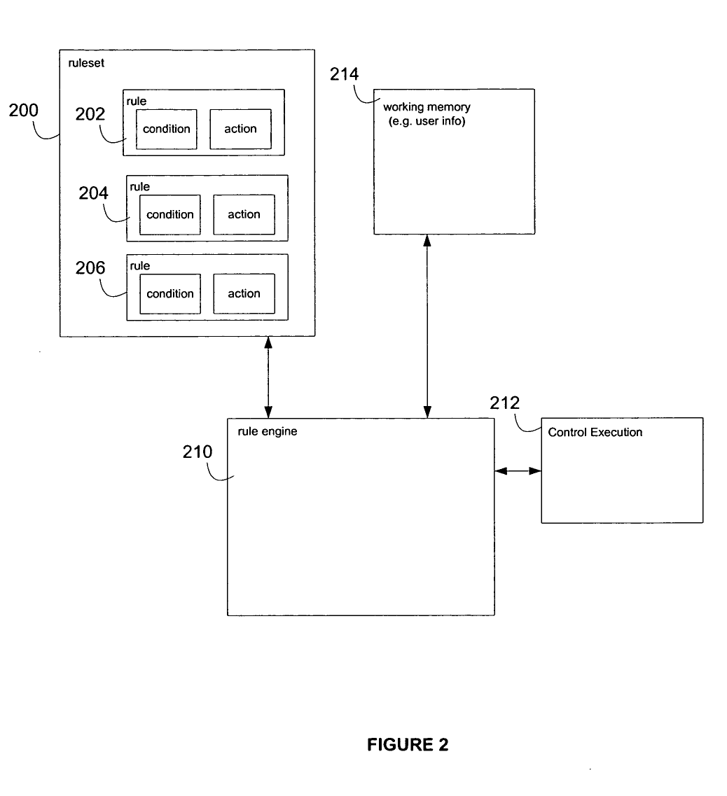

FIG. 2 illustrates an embodiment using a ruleset 200. The ruleset 200 includes a number of rules 202, 204, and 206. The rule engine 210 can evaluate the rules and send controls to be executed by the control execution unit 212. The conditions of the rules 202, 204 and 206 of the ruleset 200 can be evaluated with respect to a working memory 214. The action of the rules 202, 204 and 206 can also operate on the working memory 214.

The action can result in the personalization of a web page dislayed to a user. For example, if the amount in the shopping cart is more than a certain amount a discount indication can be displayed.

Rules can be dynamically loaded and modified, providing an efficient means of rules testing within a deployed application, via the IDE. The rulesets can be stored in or below a certain folder. The server can continually search for rulesets. Loading a ruleset into a file can cause the system to automatically initiate the use of a rule without requiring a restart of a server.

The ruleset can be an XML file that identifies rules, conditions, actions and controls within the conditions and actions. In one example, the rules ‘language’ is a usage of a Portal expressions package, extended to meet additional requirements for the rules engine. For example:

```
<cr:rule-set is-complete=“true”
xmlns=“http://www.bea.com/servers/p13n/xsd/expression/expressions/2.1.1”
  xmlns:cr=“http://www.bea.com/servers/p13n/xsd/rules/core/2.1.1”
  xmlns:literal=“http://www.bea.com/servers/p13n/xsd/expression/literal/1.0.1”
  xmlns:string=“http://www.bea.com/servers/p13n/xsd/expression/string/1.0.1”
  xmlns:xsi=“http://www.w3.org/2001/XMLSchema-instance”
  xsi:schemaLocation=“http://www.bea.com/servers/p13n/xsd/rules/core/2.1.1 rules-core-2_1_1.xsd”>
    <cr:rule is-complete=“true”>
      <cr:name>AddInteger</cr:name>
      <cr:description>Simple value test </cr:description>
      <cr:conditions>
        <equal-to>
          <variable>
            <type-alias>java.lang.String</type-alias>
          </variable>
            <literal:string>Nederland</literal:string>
        </equal-to>
      </cr:conditions>
      <cr:actions>
<cr:add-object>
            <type-alias>java.lang.Integer</type-alias>
            <arguments>
              <literal:string>10</literal:string>
            </arguments>
          </cr:add-object>
      </cr:actions>
    </cr:rule>
  </cr:rule-set>
```

In one example, Rulesets, which can end in end in *.rls, consist of several parts:
The <cr:rule-set> tag includes all references to schema used in the document (ruleset).
One or more rules, delineated by the <cr:rule> tag.
Within each rule, one or more conditions <cr:condition> and one or more actions <cr:actions>.

The declaration of controls can go into a new element, which is a child of <cr:rule>:

```
<cr:rule>
  <cr:name>ARule</cr:name>
  <cr:description></cr:description>
  <!-- One declare-control for each control dragged onto rule -->
  <cr:declare-control control-id=“name” class=“full control class name”>
    <!-- The control declaration tags, specified as annotations in
      other control container.
      This is a minOccurs=0, maxOccurs=unbounded. -->
    <cr:control-tag name=“name”>
      <!-- This is a minOccurs=0, maxOccurs=unbounded.
        The value is also optional. -->
      <cr:control-tag-value name=“name”>TheValue</cr:control-tag-
      value>
    </cr:control-tag>
  </cr:declare-control>
</cr:rule>
```

So, the following declaration in a jpf/jws/jpd:

```
/**
  * @common:control
  * @jc:location jms-url=“jndi://localhost:7001/thing” http-url=“http://
  www.bea.com/”
  * @common:security callback-roles-allowed=“Anonymous”
  */
```

private ctl.MyWSControl ws;

would look like:

```
<cr:declare-control control-id=“ws” class=“ctl.MyWSControl”>
  <cr:control-tag name=“common:control”/>
  <cr:control-tag name=“jc:location”>
    <cr:control-tag-value name=“jms-url”>jndi://localhost:7001/thing</
    cr:control-tag-value>
    <cr:control-tag-value name=”http-url”>http://www.bea.com/</
    cr:control-tag-value>
  </cr:control-tag>
  <cr:control-tag name=“common:security”>
    <cr:control-tag-value name=“callback-roles-allowed”>Anonymous</
    cr:control-tag-value>
  </cr:control-tag>
</cr:declare-control>
```

To invoke a control method for a condition, the following expression can be used in a

```
<cr:condition>:
  <!-- control-id must correspond to a control-id from a
    previous declare-control block.
    This would be an extension of exp:method-argument-list.
  -->
    <cr:call-control-method control-id=“name” name=“methodName”>
    <!-- exp:expressions that are the arguments.
      The following are examples. -->
    <!-- The request's Username property -->
    <wlcs:get-property>
      <variable>
      <type-alias>request</type-alias>
    </variable>
    <wlcs:property-set>DefaultRequestPropertySet</wlcs:property-set>
    <wlcs:name>Username</wlcs:name>
    </wlcs:get-property>
    <!-- The session object from working memory -->
    <variable>
      <type-alias>session</type-alias>
    </variable>
    <!-- A working memory object based upon class -->
    <variable>
      <type-alias>com.bea.xml.XmlObject</type-alias>
    </variable>
    <!-- A literal value -->
    <wlcs:literal>
    <wlcs:boolean>true</wlcs:boolean>
  </wlcs:literal>
</cr:call-control-method>
```

This can be used just like any of the other comparison blocks.

To invoke a control method in an action, the following expression can be used in a

```
<cr:action>:
  <!-- control-id must correspond to a control-id from a
    previous declare-control block.
    This would an extension of exp:method-argument-list.
    -->
  <cr:create-control-method-action control-id=“name” name=
  “methodName”>
    <!-- exp:expressions that are the arguments.
      The following are examples. -->
    <!-- The request's Username property -->
    <wlcs:get-property>
      <variable>
        <type-alias>request</type-alias>
      </variable>
      <wlcs:property-set>DefaultRequestPropertySet</wlcs:property-set>
      <wlcs:name>Username</wlcs:name>
    </wlcs:get-property>
    <!-- The session object from working memory -->
    <variable>
      <type-alias>session</type-alias>
    </variable>
    <!-- A working memory object based upon class -->
    <variable>
      <type-alias>com.bea.xml.XmlObject</type-alias>
    </variable>
    <!-- A literal value -->
    <wlcs:literal>
    <wlcs:boolean>true</wlcs:boolean>
  </wlcs:literal>
</cr:create-control-method-action>
```

This can assert an action object that invokes the control method.

In one example, for control methods that take arguments, it can be possible to, in XML, specify what to pass in from the following:
1. A literal value (for simple types such as String, Boolean, Long, Double, and Calendar, or a class which has a constructor that can take a String).
2. A named or typed object in working memory.
3. The result of getting a property from one of the supported ConfigurableEntity objects (user, request, session, event)

The Control instance lifecycle can be tied to the expression (or rule) evaluation context.

An IDE can be used to design the rules including the controls. The IDE can use representations of the rules and the controls and allow the rules and controls to be created, and edited.

A renderer system for the rules can support Control-specific renderers and can be configurable by 3rd-parties via an extension model, such as the WLW extension.xml model A default renderer can include reusable click-handlers for choosing what type of argument and, then, the details of how to get the argument; these can be used by 3rd-party Control renderers to get similar behavior.

A PropertyEditor can show Control-specific properties and editors when a Control or method is selected. The DataPalette for the expression/rule editor can include the “ControlslAdd” line like in the other editors, as well as having those in the Insert. It can be possible to perform the following additional drag-and-drop operations on the expression/rule editor:
Dragging a Control file from the Application window (same as using Controls|Add in DataPalette).
Dragging a method from underneath a Control's tree in the DataPalette. This can be drop-region aware as needed.

Control-specified icons, labels, and tooltips can be used where appropriate, including the default rendering behavior, the DatePalette, and any menus or pickers. A context-menu option can be used for opening the Control source from the editor for Controls whose source is available.

Removing the Control from the rule, if the control is used anywhere, can prompt the user if they also want to remove the usages of the Control.

In one embodiment, it is possible to modify control method parameters as follows:
literal values within the same type (e.g. changing true to false, ‘Red’ to ‘Green’)
changing the property set and property name for ConfigurableEntity property retrieval (e.g. from the request's Username to the request's User Identifier), as well as between the available types of ConfigurableEntity's (e.g. from request's Username to user's FirstName)

In one example, the rule engine includes a core expression engine and additional logic that interacts with the expression engine and with other units accessing the rule engine. This additional logic can be amended to interact with a control execution unit to launch controls and to send information from controls in the condition to the expression engine.

In one embodiment, a map of control-id to Control instance can be initialized when the rule is first evaluated. The map may be in an object in the working memory. In one example, if a control has already been initialized, it will not be reinitialized. If an error occurs during declaration of a Control, a log message can be written and a marker object can be placed in the Control map.

The invocation of a control can be modified to explicitly pass the original HttpServletRequest so the control code can redeploy the application or web app. The control declaration logic can unwrap this request to find an actual HttpServletRequest. For the methods that don't require it, the internal rule code can attempt to get an HttpServletRequest from the input objects. If more than one is found, the first ServietRequestimpl object can be used via the unwrapping logic. The original HttpServletRequest will generally be either the real WLS request or a pageflow ScopedRequest (which we can unwrap with ScopedUtils) or a HttpServletRequestWrapper from a filter (which we can also unwrap). This unwrapping can occur until a WLS ServietRequestImpl is found.

In one embodiment, a CallControlMethodOperator will try to get the Control specified by the control-id from the Control map on the Rule or object asserted into working memory. If the Control isn't initialized there, this will log a message and return false. Otherwise, it can use the evaluated children Objects as arguments to the method, and use reflection to call that method. Rules such as the following can be used based upon the return value of the control method as to whether the operator should return true or false:

| Control Method | | Operator |
|---|---|---|
| for Return Type | Control Method Return Value | Return Value |
| Boolean | true | true |
| | false | false |
| Number | intValue( )!=0 | true |
| | inVaue( )= =0 | false |
| String | !=null&&length( )>0 | true |
| | = = null ∥ length( )= =0 | false |
| Object | !-null | true |
| | null | false |
| Void | void | true |

If the method invocation fails or throws an Exception from the control, this can be logged and a false can be returned.

A CreateControlMethodActionOperator can assert a ControlMethodAction into working memory (if the Control at control-id was initialized), which the caller can retrieve. We can put a base Action interface such as:

public interface Action
{
public void run( ) throws ActionException;
}

can be extended by other code. ControlMethodAction can get initialized with the Control instance based upon control-id, the method name, and the evaluated children Objects as arguments. Its run( ) method can do the reflection to invoke the method. The return value would be ignored in this case.

RuleModel can be updated to have methods like:

public ControlDeclaration [symbol] getControlDeclaration( );
public ControlDeclaration getControlDeclaration(String controlId);
public void addControlDeclaration(ControlDeclaration d);
public void removeControlDeclaration(ControlDeclaration d);

The mutation methods can follow the existing fromUndo pattern, and can handle the UndoableEdit, firing the event, and updating the IsComplete state the same as other mutating methods. ControlDeclaration can look like:

```
public class ControlDeclaration extends RulePartModel
{
  public String getControlId( );
  public void setControlId(String controlId);
  public String getControlClassName( );
  public void setControlClassName(String className);
  public ControlTag [symbol] getControlTags( );
  public void setControlTags(ControlTag [symbol] tags);
  public IControlLocator getControlLocator( );
}
public class ControlTag
{
  /** The correspond annotation name (e.g. @jc:location).
    */
  public String getName( );
  /** The String name/value pairs. The value part is optional.
    * This can be empty.
    */
  public Map getProperties( );
}
```

In one example, a ControlDeclaration instance can be complete when everything is specified.

Inside a rule's ClauseModels, we can have two new types can signify a control method and a control method action, such as:

```
public class ControlMethodCall extends ClauseModel
{
  public String getControlId( );
  public void setControlId(String controlId);
  /** Get the ControlDeclaration of the control from the RuleModel.
    */
  public ControlDeclaration getControlDeclaration( );
  public String getMethodName( );
  public void setMethodName(String methodName);
  /** Each parameter can be either:
    * 1. A TypeAlias object.
    * 2. A Property object.
    * 3. A String, Long, Double, Boolean, or TimeInstant object.
    */
  public Object [symbol] getParameters( );
  public void setParameters(Object [symbol] parameters);
}
public class CreateControlMethodCall extends ClauseModel
{
  public String getControlId( );
  public void setControlId(String controlId);
  /** Get the ControlDeclaration of the control from the RuleModel.
    */
  public ControlDeclaration getControlDeclaration( );
  public String getMethodName( );
  public void setMethodName(String methodName);
  /** Each parameter can be either:
    * 1. A TypeAlias object.
    * 2. A Property object.
    * 3. A String, Long, Double, Boolean, or TimeInstant object.
    */
  public Object [symbol] getParameters( );
  public void setParameters(Object [symbol] parameters);
}
public class TypeAlias
{
  /** Alias name constants for the standard objects.
    */
  public static final String USER = “user”;
  public static final String REQUEST = “request”;
  public static final String SESSION = “session”;
  public static final String EVENT = “event”;
  public static final String RANDOM_NUMBER = “randomNumber”;
  public static final String SHOPPING_CART = “shoppingCart”;
  public static final String CLASSIFICATION = “classification”;
  public static final String NOW = “now”;
  /** The type alias string, either one of the constants or a class name.
    */
  public String getAliasName( );
}
```

When a Control method is dropped, we can look at the signature. For each argument class type that matches a well-known object, we can initialize that parameter with the appropriate TypeAlias. Otherwise, we can put up a select link which can bring up a dialog to first choose between getting a user/request/session/event property, a literal, or choosing a type alias. Then, depending upon what's selected, an appropriate picker can be presented. For class name TypeAlias'es, either a class picker or a class picker text field can be used to help the developer with class name completion.

In one embodiment, there can be three different types of Controls: built-in Controls, portal controls, and custom Controls.

Built-in controls provide easy access to enterprise resources. By way of a non-limiting example, a database control makes it easy to connect to a database and perform operations on the data using simple SQL statements, whereas an EJB control enables users to easily access an EJB. Built-in controls provide simple properties and methods for customizing their behavior, and in many cases users can add methods and callbacks to further customize the control. In one embodiment, a portal control is a kind of built-in Java control specific to the portal environment. If users are building a portal, users can use portal controls to expose tracking and personalization functions in multi-page portlets.

In one embodiment, users can also build a custom control from scratch. Custom controls are especially powerful when used to encapsulate business logic in reusable components. It can act as the nerve center of a piece of functionality, implementing the desired overall behavior and delegating subtasks to built-in Controls (and/or other custom controls). This use of a custom Java control ensures modularity and encapsulation. Web services, JSP pages, or other custom Controls can simply use the custom Java control to obtain the desired functionality, and changes that may become necessary can be implemented in one software component instead of many.

In one embodiment, controls are reusable components that can be used anywhere within an application. Users can use built-in controls provided with the IDE, or can create their own. In one embodiment, a framework that supports controls is flexible, supporting a wide variety of uses for controls. By way of a non-limiting example, controls can:
Contain business logic users want to keep separate from other application code, or which may be reused.
Provide access to resources such as databases or other resources.
Collect logic that coordinates multiple actions, such as those that involve multiple database queries, calls to Enterprise JavaBeans (with the EJB control), and so on. A control can participate in the implicit transaction of a conversational container, such as a web service that is conversational.

In one embodiment, the IDE can provide several built-in controls, mostly designed to provide access to resources. By way of a non-limiting example, users can use a built-in EJB control for access to Enterprise JavaBeans®, a JMS control for access to the Java Message Service, and so on. Users can build their own controls that are based on the same framework on which built-in controls are based. Users can design a custom control from the ground up, designing its interface and business logic, adding other controls as needed. Users can design a custom control for use in one project, or users can design a custom control for easy reuse in multiple projects.

Built-in controls and custom controls that have been set up for use in multiple projects, can be displayed in the IDE's graphical user interface (GUI) (e.g., via a palette or a menu). By default, a control palette can be displayed which allows a user to add controls to a design by interacting with the palette (e.g., by dragging and dropping the control onto a work area).

When a control is in a user's design, its methods and callbacks can also displayed in a GUI. Users can also drag methods and callbacks onto a design canvas to create “pass-through” methods. A pass-through is a shortcut way to call a control's method from a user's current design.

A Java control is an object that encapsulates business logic or provides access to a resource. The control model allows a developer to access the business logic or resource in a consistent, straightforward manner as though it was a simple Java object.

IDEs, such as WebLogic Workshop, can includes built-in controls to simplify access to common resources such as databases, JMS (Java Message Service) queues, or EJBs (Enterprise JavaBeans). Developers may also implement custom Java controls to encapsulate any business logic or provide access to resources not covered by built-in controls.

Each control can be implemented as a Java class. Controls can be are managed by the WebLogic Workshop runtime like EJBs are managed by J2EE's EJB container. The runtime can provide automatic transactions, asynchrony, state management and other services. A controls can also define custom annotations and wizards that integrate seamlessly with the WebLogic Workshop IDE.

A Java control is defined in a JCS (Java Control Source) file with the jcs extension. Java controls can be extensible, meaning that the control can be customized via Javadoc annotations. Customized instances of an extensible control are defined in JCX (Java Control Extension) files with the jcx extension.

A Java control may be used from a web service, a page flow, a business process or another Java control.

In one embodiment, the rules engine can be part of a portal product, such as Weblogic Portal. A portal represents a Web site that provides a single point of access to applications

Portals are becoming more and more important to companies, who have an ever-increasing need to provide employees, partners, and customers with an integrated view of applications, information, and business processes. WebLogic Portal meets these needs, allowing companies to build portals that combine functionality and resources into a single interface while enforcing business policies, processes, and security requirements, and providing personalized views of information to end users.

From an end user perspective, a portal is a Web site with pages that are organized by tabs or some other form of navigation. Each page contains a nesting of sub-pages, or one or more portlets—individual windows that display anything from static HTML content to complex Web services. A page can contain multiple portlets, giving users access to different information and tools in a single place. Users can also customize their view of a portal by adding their own pages, adding the portlets they want to it, and changing the look and feel of the interface.

Logic encompassed by the rules can form a part of the Portal personalization process. In WebLogicPortal®:
1. The Rules Management Framework in WebLogic Portal® provides run-time capabilities for providing personalized content based on externalized rules.
2. The Rules Manager EJB is a scalable, stateless J2EE entry point into the underlying BEA Rules Engine. It provides the run-time services necessary to execute the business rules defined by the user.
3. Two Portal controls, the RulesManagerControl and the RulesExecutorControl, provide easy access to the Rules Manager EJB.

Some rules are automatically included with Portal, such as content selectors and campaigns. The user may also create their own customized rules by hand, leveraging Portal's Expressions package and using Xml Spy to validate those rules before deploying them into Portal.

The Rules Engine can apply a set of rules to objects in working memory. This working memory can be populated with input from the calling objects, such as the user profile request session, among other things. In this way, a representation of the user's profile exists in working memory before any rules are actually fired.

Rules can be executed within a context, which associates a rule set with working memory. The context provides an interface to the Rules Engine that controls the relationship between the rule part of the application and the working memory.

This working memory is operated on by the production rules, which are contained in rule sets. The left-hand sides (LHS) or conditions of these rules are evaluated against the objects in the working memory. If the patterns on the LHS are matched, then the actions contained in the right-hand side (RHS) of the rules are performed. Some of these actions may add new objects into the working memory. For example, if our Classifier rule tests for USER.age>45, then we might add a new Classification object into working memory.

The production system is executed by performing the following operations:
1. Match: Evaluates the LHSs of the rules to determine which are satisfied given the current contents of working memory.
2. Conflict resolution: Selects one rule with a satisfied LHS. If no rules have satisfied the LHSs, halts the interpreter.
3. Act: Performs the actions in the RHS of the selected rule.
4. Go to step 1.

Rules can continue to operate on the working memory until the conflict resolution set is zero (that is, no more rules can fire).

After the Rules Engine has halted, the rules manager component can returns a list of objects remaining in working memory. A likely scenario will have an object remaining of the type “Classification” or “ContentQuery.”

The Rules Manager can then iterate over these remaining objects and filter them using an optional Object filter. The filter can selectively ignore objects or mutate them.

There are several steps involved in using the Portal Rules Service. In one embodiment, the rules are created, and then deployed into a running instance of a server such as WebLogic® Server. Next, the rules are evaluated, and the results are optionally filtered before being returned to the user. Finally, the user leverages the results of evaluating those rules in the application code.

Each application is associated with its own instance of data. This data can be located at a data folder such as the application's META-INF/data folder. Any data in or beneath that folder can be deployable by data sync. A folder called ‘rulesets’ can be used for the rulesets.

The rules service can use Portal Data Sync to deploy its rulesets into the running server. This means the user need only drop the rulesets into the data sync folder to get the rulesets to deploy. If the rulesets are already in the data sync folder, modifying the ruleset can cause those changes to be picked up by data sync and the rules service repository can refresh that instance of the ruleset. Ruleset file names end with *.rls to be picked up by the rules manager.

So, for example, if my app is drtApp, rulesets can be put in the folder drtApp/META-INF/data/rulesets. when the server first starts and the first invocation of the rules service is made, all the rulesets in this folder can be loaded by data sync and can be available to the rules engine.

Now, to refer to the ruleset URI in the rules controls or EJB APIs, the filenames can be relative to the META-INF/data folder. For example, if I dropped simple.rls into drtApp/META-INF/data/rulesets, one can refer to it with the URI ‘/rulesets/simple.rls’.

Simply by changing the contents of the data sync ruleset folder, the modified rulesets can be reloaded (if changed) or removed from the rules service (if deleted).

This means you can tweak your rules, or debug parsing errors, as the server is running. You do not have to restart the server to change your rulesets.

Portal controls graphical components available in WebLogic® Workshop. The RulesExecutorControl is one such control. It allows the execution of named rules and rulesets, and can optionally filter the results after the ruleset has evaluated.

This control has several properties that must be configured before it is used:
The URI of the ruleset containing the rule. This URI is relative to the application's META-INF/data folder.
The name of the rule to evaluate. If no rule is specified, then all the rules in the ruleset can evaluate.
An optional filter parameter, described more in detail below.

TheRulesExecutorControl actually wraps the RulesManager EJB, which is available in all Portal applications in the p13n_ejb.jar file and may be used directly to invoke the rules service (though controls are preferred).

Evaluation of the ruleset may be considered in these steps:
The Portal rules engine initializes, creating its “working memory.”
The rules control can describe which ruleset to use, and optionally, which rules to evaluate (defaults to all), and whether to filter results. These are all parameters that may be configured on the Rules control and are passed into the rules engine to evaulate the rule.
The developer creates and add objects to the “working memory”. Example objects might be the user's profile, the Request, etc. These parameters are passed in as an argument to the rule control's evaluate( ) method.
The rules engine is invoked via the RulesExecutorControl.
The rules engine creates its Rete Network from the input ruleset and input objects.
The rules engine fires repeatedly, executing rules according to the state of the input objects and rule conditions.
After the rules engine has reached a state where no more rules will fire, the results are in working memory, along with all of the original input objects.
Because the input objects are part of the results, you may choose to filter the results based on a class. For example, you can specify that only results of class com.bea.p13n.usermgmt.profile.ProfileWrapper are returned. The examples in the following sections illustrate the creation and use of filters.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. A method comprising:
evaluating a condition of a rule; and
if the condition evaluates to true, doing a step defined by an action of the rule; wherein the evaluating of the condition or doing the step defined by the action includes executing a control defined in condition or action of the rule, the control being an object that encapsulates business logic or provides access to a resource.

2. The method of claim 1, wherein the rule is part of a ruleset.

3. The method of claim 1, wherein the rule is defined by XML.

4. The method of claim 3, wherein the XML is part of ruleset XML.

5. The method of claim 3, wherein the XML defines the condition and action.

6. The method of claim 4, wherein the XML defines a control within the condition or action portion of the XML.

7. The method of claim 4, wherein the rule is evaluated by a rule engine.

8. The method of claim 1, wherein the rule condition is evaluated with respect to a working memory.

9. The method of claim 8, wherein the working memory includes information concerning a user.

10. The method of claim 1, wherein result of the action personalizes a web page dislayed to a user.

11. A machine readable medium having instructions stored thereon that when executed by a processor cause a system to:
evaluate a condition of a rule; and
if the condition evaluates to true, doing a step defined by an action of the rule; wherein the evaluating of the condition or doing the step defined by the action includes executing a control defined in condition or action of the rule, the control being an object that encapsulates business logic or provides access to a resource.

12. The machine readable medium of claim 11, wherein the rule is part of a ruleset.

13. The machine readable medium of claim 11, wherein the rule is defined by XML.

14. The machine readable medium of claim 13, wherein the XML is part of ruleset XML.

15. The machine readable medium of claim 13, wherein the XML defines the condition and action.

16. The machine readable medium of claim 14, wherein the XML defines a control within the condition or action portion of the XML.

17. The machine readable medium of claim 14, wherein the rule is evaluated by a rule engine.

18. The machine readable medium of claim 11, wherein the rule condition is evaluated with respect to a working memory.

19. The machine readable medium of claim 18, wherein the working memory includes information concerning a user.

20. The machine readable medium of claim 11, wherein result of the action personalizes a web page dislayed to a user.
